(19) United States
(12) Patent Application Publication
(10) Pub. No.: US 2025/0376070 A1
(43) Pub. Date: Dec. 11, 2025

(54) Traction Battery Controller Using Active Charge Control, Customized to Type of Charge Station Charging Current, to Detect Battery Operating Characteristics during Battery Charging

(71) Applicant: Ford Global Technologies, LLC, Dearborn, MI (US)

(72) Inventor: Yonghua Li, Ann Arbor, MI (US)

(73) Assignee: Ford Global Technologies, LLC, Dearborn, MI (US)

(21) Appl. No.: 18/737,144

(22) Filed: Jun. 7, 2024

(51) Int. Cl. B60L 58/12; B60L 53/62; H01M 10/44; H02J 7/00

(52) U.S. Cl. CPC B60L 58/12; B60L 53/62; H01M 10/44; H02J 7/00716; B60L 2260/44

(57) ABSTRACT

A method includes varying a charging current, from a charge station for use in charging a battery, depending on a type of the charging current. The battery may be a traction battery of an electrified vehicle. The method further includes measuring a voltage of the battery as the charging current is being varied, driving an estimator, that utilizes voltage feedback based on a model of the battery to provide parameter/state estimations of the battery, with the voltage to output a state-of-charge (SOC) of the battery, detecting an operating characteristic of the battery using the SOC, and controlling the battery according to the operating characteristic.

### TECHNICAL FIELD

The present disclosure relates to detecting operating characteristics of a traction battery of an electrified vehicle for use in controlling the operation of the traction battery and/or the vehicle.

### BACKGROUND

An electrified vehicle includes a traction battery for providing power to a motor of the vehicle to propel the vehicle. Operating characteristics of the traction battery, such as its charge capacity, state-of-charge, and power capability, may be monitored for use in controlling the operation of the traction battery and/or the vehicle.

### SUMMARY

A method includes varying a charging current, from a charge station for use in charging a battery, depending on a type of the charging current. The battery may be a traction battery of an electrified vehicle. The method further includes measuring a voltage of the battery as the charging current is being varied; driving an estimator with the voltage to output a state-of-charge (SOC) of the battery; and detecting an operating characteristic of the battery using the SOC.

The charging current may be varied for a duration of time depending on the type of the charging current.

The charging current may be varied for a greater duration of time when the charging current is AC charging current than when the charging current is DC charging current.

The charging current may be varied for one or more instants depending on the type of the charging current. The method further includes unchanging the charging current other than during the one or more instants.

The charging current may be varied for multiple instants when the charging current is AC charging current. Ampere integration measurements may be performed while the charging current is being unchanged, wherein the instants are delineated according to SOC intervals based on the SOC and the Ampere integration measurements performed between neighboring instants.

The charging current may be varied for just one instant when the charging current is DC charging current. The one instant may occur when the charging current is initiated from the charge station for use in charging the battery. An Ampere integration measurement may be performed while the charging current is being unchanged and, upon the charging current from the charge station for use in charging the battery being terminated, a final SOC based on the SOC and the Ampere integration measurement may be detected.

A system includes a controller configured to vary a charge current, from a charge station for use in charging a battery, depending on a type of the charge current. The system further includes a sensor configured to measure a terminal voltage of the battery as the charge current is being varied. The controller is further configured to drive an estimator with the terminal voltage to output a SOC of the battery and to charge/discharge the battery based on the SOC.

An electrified vehicle includes a traction battery and a controller. The controller is configured to vary a charge current, from a charge station for use in charging the traction battery, depending on a type of the charge current, measure a terminal voltage of the traction battery as the charge current is being varied, drive an estimator, that utilizes voltage feedback based on a model of the battery to provide parameter/state estimations of the battery, with the terminal voltage to output a SOC of the battery, and to charge/discharge the traction battery based on the SOC.

### BRIEF DESCRIPTION OF THE DRAWINGS

FIG. 1 illustrates a block diagram of a battery electric vehicle (BEV);

FIG. 2 illustrates a block diagram of an arrangement for a traction battery controller of the BEV to monitor a traction battery of the BEV;

FIG. 3 illustrates a block diagram of the traction battery controller, the traction battery controller including an operating characteristics estimator for estimating operating characteristics of the traction battery;

FIG. 4 illustrates a schematic diagram of an equivalent circuit model (ECM) of the traction battery;

FIG. 5A illustrates a flowchart depicting operation of the traction battery controller when the traction battery is being charged at a charge station (public, commercial, residential, etc.) that provides AC charging current to the vehicle, the operation including the traction battery controller using active charge control of the AC charging current, in a manner that is customized to AC charging, for detecting operating characteristics of the traction battery while the traction battery is being charged by an AC charger of the vehicle that converts the AC charging current into a DC charging current and charges the traction battery with the DC charging current; and

FIG. 5B illustrates a flowchart depicting operation of the traction battery controller when the traction battery is being charged at a charge station that provides DC charging current to the vehicle, the operation including the traction battery controller using active charge control of the DC charging current, in a manner that is customized to DC charging, for detecting operating characteristics of the traction battery while the traction battery is being charged with the DC charging current.

### DETAILED DESCRIPTION

Detailed embodiments of the present disclosure are disclosed herein; however, it is to be understood that the disclosed embodiments are merely exemplary of the present disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

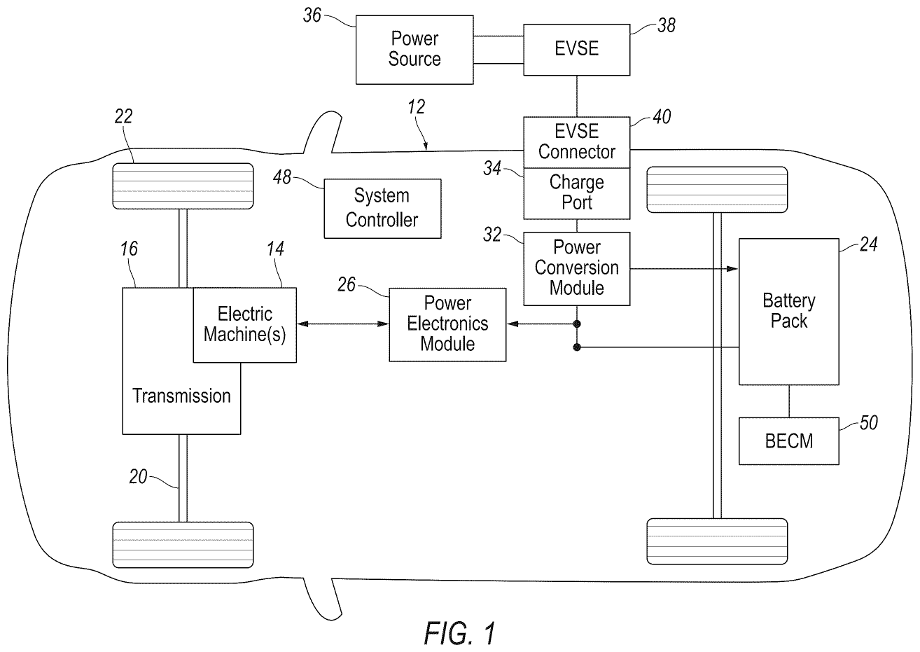

Referring now to FIG. 1, a block diagram of an electrified vehicle (EV) 12 in the form of a battery electric vehicle (BEV) is shown. BEV 12 includes a powertrain having one or more traction motors (“electric machine(s)”) 14, a traction battery (“battery” or “battery pack”) 24, and a power electronics module 26 (e.g., an inverter). In the BEV configuration, traction battery 24 provides all of the propulsion power and the vehicle does not have an engine. In other variations, the EV may be a plug-in or regular hybrid electric vehicle (PHEV, HEV) further having an engine.

Traction motor 14 is part of the powertrain of BEV 12 for powering movement of the BEV. In this regard, traction motor 14 is mechanically connected to a transmission 16 of BEV 12. Transmission 16 is mechanically connected to a drive shaft 20 that is mechanically connected to wheels 22 of BEV 12. Traction motor 14 can provide propulsion capability to BEV 12 and is capable of operating as a generator. Traction motor 14 acting as a generator can recover energy that may normally be lost as heat in a friction system of BEV 12.

Traction battery 24 stores electrical energy that can be used by traction motor 14 for propelling BEV 12. Traction battery 24 is a direct current (DC) battery that typically provides a high voltage (HV) DC output. Traction battery 24 may receive a DC input to be recharged (i.e., charged). Traction battery 24 is electrically connected to power electronics module 26. Traction motor 14 is also electrically connected to power electronics module 26. Power electronics module 26, such as an inverter, provides the ability to bi-directionally transfer energy between traction battery 24 and traction motor 14. For example, traction battery 24 may provide a DC voltage while traction motor 14 may require a three-phase alternating current (AC) current to function. Inverter 26 may convert the DC voltage to a three-phase AC current to operate traction motor 14. In a regenerative mode, inverter 26 may convert three-phase AC current from traction motor 14 acting as a generator to DC voltage compatible with traction battery 24.

In addition to providing electrical energy for propulsion of BEV 12, traction battery 24 may provide electrical energy for use by other electrical systems of the BEV including HV loads such as electric heater and air-conditioner systems, and low-voltage (LV) loads such as an auxiliary battery.

Traction battery 24 is rechargeable by an external power source 36 (e.g., the grid). External power source 36 may be electrically connected to electric vehicle supply equipment (EVSE) 38. EVSE 38 provides circuitry and controls to control and manage the transfer of electrical energy between external power source 36 and BEV 12. External power source 36 may provide DC or AC electric power to EVSE 38. EVSE 38 may have a charge connector 40 for plugging into a charge port 34 of BEV 12. A power conversion module 32 of BEV 12, such as an on-board charger having an AC/DC converter, converts AC electrical power supplied from EVSE 38 into DC electrical power having proper DC voltage and current levels and provides the DC electrical power to traction battery 24 for recharging the traction battery. Power conversion module 32 transfers DC electrical power supplied from EVSE 38 directly to traction battery 24 for recharging the traction battery. Power conversion module 32 may interface with EVSE 38 to coordinate the delivery of electrical power to traction battery 24.

The various components described above may have one or more associated controllers to control and monitor the operation of the components. The controllers can be microprocessor-based devices. The controllers may communicate via a serial bus (e.g., Controller Area Network (CAN)) or via discrete conductors.

For example, a system controller 48 (“vehicle controller”) is present to coordinate the operation of the various components. Controller 48 includes electronics, software, or both, to perform the necessary control functions for operating BEV 12. Controller 48 may be a combination vehicle system controller and powertrain control module (VSC/PCM). Although controller 48 is shown as a single device, controller 48 may include multiple controllers in the form of multiple hardware devices, or multiple software controllers with one or more hardware devices. In this regard, a reference to a “controller” herein may refer to one or more controllers.

Controller 48 implements a battery energy control module (BECM) 50. BECM 50 is in communication with traction battery 24. BECM 50 is a traction battery controller operable for managing the charging and discharging of traction battery 24 and for monitoring operating characteristics of the traction battery. BECM 50 is operable to implement algorithms to detect (e.g., estimate) the operating characteristics of traction battery 24. BECM 50 controls the operation and performance of traction battery 24 based on the operating characteristics of the traction battery. The operation and performance of other systems and components of BEV 12 may be controlled by BECM 50 and/or other controllers of the BEV based on the operating characteristics of traction battery 24.

Operating characteristics of traction battery 24 include its charge capacity (“capacity”) and its state-of-charge (SOC). The capacity of traction battery 24 is indicative of the maximum amount of electrical energy that the traction battery may store. The SOC of traction battery 24 is indicative of a present amount of electrical charge stored in the traction battery. The SOC of traction battery 24 may be represented as a percentage of the maximum amount of electrical charge that may be stored in the traction battery (i.e., as a percentage of the capacity). BECM 50 may output the SOC of traction battery 24 to inform the driver of BEV 12 how much charge remains in the traction battery, similar to a fuel gauge.

Another operating characteristic of traction battery 24 is its power capability. The power capability of traction battery 24 is a measure of the maximum amount of power the traction battery can provide (i.e., discharge) or receive (i.e., charge) for a specified time period. As such, the power capability of traction battery 24 corresponds to discharge and charge power limits which define the amount of electrical power that may be supplied from or received by the traction battery at a given time. These limits can be provided to other vehicle controls, for example, through controller 48, so that the information can be used by systems that may draw power from or provide power to traction battery 24. Vehicle controls are to know how much power traction battery 24 can provide (discharge) or take in (charge) in order to meet the driver demand and to optimize the energy usage. As such, knowing the power capability of traction battery 24 allows electrical loads and sources to be managed such that the power requested is within the limits that the traction battery can handle.

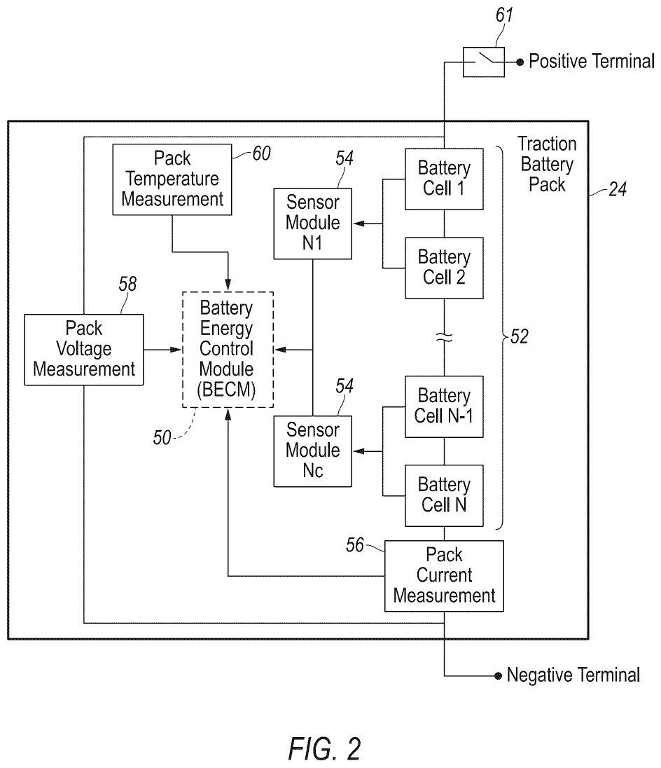

Referring now to FIG. 2, with continual reference to FIG. 1, a block diagram of an arrangement for BECM 50 to monitor traction battery 24 is shown. As indicated in FIG. 2, traction battery 24 is comprised of a plurality of battery cells 52. Battery cells 52 are physically connected together (e.g., connected in series as shown in FIG. 2) between a positive terminal (i.e., a positive power bus) and a negative terminal (i.e., a negative power bus). More generally, traction battery 24 comprises one or more battery cell modules that are electrically connected together, and each battery cell module comprises one or more battery cells 52 that are electrically connected together. For simplicity of discussion, it is assumed that the battery cell module(s) are connected in series and that battery cells 52 are connected in series.

BECM 50 is operable to monitor pack level (i.e., traction battery level) characteristics of traction battery 24 such as battery current 56, battery voltage 58, and battery temperature 60. Battery current 56 is the current outputted (i.e., discharged) from or inputted (i.e., charged) to traction battery 24. Battery voltage 58 is the terminal voltage of traction battery 24.

BECM 50 is also operable to measure and monitor battery cell level characteristics of battery cells 52 of traction battery 24. For example, terminal voltage, current, and temperature of one or more of battery cells 52 may be measured. BECM 50 may use a battery sensor 54 to measure the battery cell level characteristics. Battery sensor 54 may measure the characteristics of one or multiple battery cells 52. BECM 50 may utilize Nc battery sensors 54 to measure the characteristics of all battery cells 52. Each battery sensor 54 may transfer the measurements to BECM 50 for further processing and coordination. Battery sensor 54 functionality may be incorporated internally to BECM 50.

Traction battery 24 may have one or more temperature sensors such as thermistors in communication with BECM 50 to provide data indicative of the temperature of battery cells 52 of the traction battery for the BECM to monitor the temperature of the traction battery and/or the battery cells. BEV 12 may further include a temperature sensor to provide data indicative of ambient temperature for BECM 50 to monitor the ambient temperature.

BECM 50 controls the operation and performance of traction battery 24 based on the monitored traction battery and battery cell level characteristics. For instance, BECM 50 may use the monitored characteristics to detect operating characteristics of traction battery 24 (e.g., the capacity, the SOC, the power capability, etc., of the traction battery) such as for use in controlling the traction battery and/or BEV 12.

As shown in FIG. 2, one or more contactors 61 is provided to inhibit or permit electric current from traveling through the power buses to/from traction battery 24. Specifically, contactors 61 are operable to electrically decouple traction battery 24 from/to a charge/discharge system of BEV 12. The charge/discharge system includes components that either charge traction battery 24 or act as a load to draw electric power from the traction battery. Thus, the charge/discharge system may include inverter 26 and power conversion module 32 among other components. Contactors 61 may be placed in various suitable positions in BEV 12, such as between the positive power bus and inverter 26.

BECM 50 is configured to open or close contactors 61 based on a message/request from controller 48. Controller 48 is configured to detect when BEV 12 is to be turned ON (i.e., key on) or OFF (i.e., key off) based on an activation input (e.g., a user pressing a button associated with activating/deactivating the BEV). When BEV 12 is to be turned ON, controller 48 provides an activation request to BECM 50 to close contactors 61, thereby coupling traction battery 24 to the charge/discharge system. When BEV 12 is to be turned OFF, controller 48 provides a deactivation request to BECM 50 to open contactors 61, thereby decoupling traction battery 24 from the charge/discharge system. In addition, controller 48 is configured to have BECM 50 close contactors 61 by sending the activation request when traction battery 24 is to be charged or to be discharged. Likewise, controller 48 is configured to have BECM 50 open contactors 61 by sending the deactivation request when traction battery 24 is not to be charged or discharged.

BECM 50 is configured to open contactors 61 when discharge or charge limits are exceeded or about to become exceeded to thereby decouple traction battery 24 from the charge/discharge system. Of course, BECM 50 is configured to operate traction battery 24 so that the traction battery does exceed the discharge and charge limits while the traction battery is coupled to the charge/discharge system.

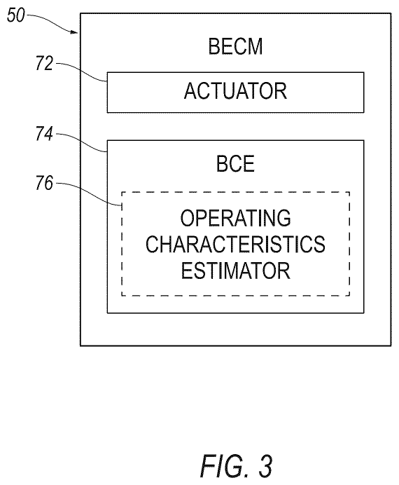

Referring now to FIG. 3, with continual reference to FIG. 1, a block diagram of BECM 50 is shown. BECM 50 includes an actuator 72 for operating contactors 61 in the closed/opened positions. BECM 50 further includes a battery characteristics estimator (BCE) 74. BCE 74 is configured to estimate operational characteristics of traction battery 24 including the capacity, the SOC, and the power capability of the traction battery. BCE 74 includes an estimator 76 to estimate the operating characteristics of traction battery 24. The operation carried out by BCE 74 (more generally, BECM 50) in estimating the operating characteristics of traction battery 24 will now be described.

As known by those of ordinary skill in the art, BECM 50 may measure operating characteristics of traction battery 24, including its capacity, SOC, and power capability, by using an observer, wherein a battery model (i.e., an “Equivalent Circuit Model” (ECM)) is used for construction of the observer, with measurements of battery current, battery terminal voltage, and battery temperature. BECM 50 may estimate values of parameters of the ECM (e.g., resistances and capacitances of circuit elements of the ECM) and values of states of the ECM (e.g., voltages and currents across circuit elements of the ECM) through recursive estimation based on such measurements. For instance, BECM 50 may use some adaptive estimation method, such as a Kalman filter or an extended Kalman filter (EKF) (collectively “Kalman filter” or “EKF”), to estimate the values of the model parameters and model states.

As an overview, a Kalman filter is an algorithm for estimating the internal state of traction battery 24 given the ECM and measurements of battery current, battery terminal voltage, and battery temperature. The input to the ECM is the measured battery current and the output of the ECM is the measured battery terminal voltage. The Kalman filter predicts what it expects to see as the battery terminal voltage given its present internal state estimate and the measured battery current; compares its estimate of the battery terminal voltage to the measured battery terminal voltage; and updates the values of the parameters and states of the ECM accordingly, in the direction of reducing the estimation error of the estimated battery terminal voltage.

As set forth, an accurate model of traction battery 24 enables BECM 50 to properly control the traction battery which directly affects vehicle performance and driving range for a given full charge. ECMs are widely used in electrified vehicle traction battery control systems in order to satisfy real time control system requirements for calculation speed and RAM/ROM usage. Particularly, an n-RC ECM where n=1 or 2 is widely used (an n-RC ECM is a type of ECM having “n” RC circuit elements each including a resistor (“R”) parameter and a capacitor (“C”) parameter; with n=1, a 1-RC ECM includes one such RC circuit element; and with n=2, a 2-RC ECM includes two such RC circuit elements). As indicated, the parameters for the ECM are learned by BECM 50 with an online learning method such a Kalman filter.

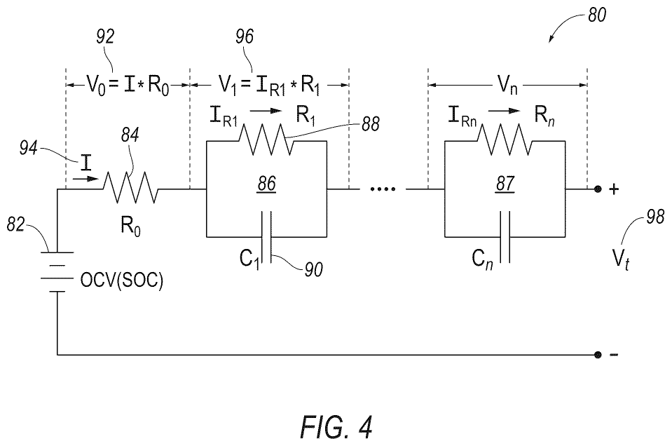

Referring now to FIG. 4, with continual reference to FIG. 1, a schematic diagram of an ECM 80 of traction battery 24 is shown. Per ECM 80, traction battery 24 is modeled as a circuit having in series a voltage source (OCV/(SOC)) 82, a resistor R₀ 84, a first RC pair 86 having a first resistor R₁ 88 and a first capacitor C₁ 90 connected in parallel, and one or more such additional RC pairs 87. As such, ECM 80 is an n-RC ECM where n≥2.

Voltage source 82 represents the open-circuit voltage (OCV) of traction battery 24. The OCV of traction battery 24 depends on the state-of-charge (SOC) of the traction battery and the temperature of the traction battery. The OCV of traction battery 24 is not readily measurable. Given an estimate of the OCV of traction battery 24 and the measured temperature, BECM 50 can measure the SOC of the traction battery.

Resistor R₀ 84 represents an internal resistance of traction battery 24. The RC pairs represent the diffusion process of traction battery 24. As such, the diffusion process of traction battery 24 in ECM 80 is described with RC pairs R₁ and C1, . . . , Rₙ and Cₙ. Voltage V₀ 92 is the voltage drop across resistor R₀ 84 due to battery current I 94 which flows across resistor R₀ 84. Voltage V₁ 96 is the voltage drop across first RC pair 86 due to battery current I_{R1} which flows across resistor R₁ 88. A voltage drop is across each additional RC pair 87. Voltage Vt 98 is the voltage across the terminals of traction battery 24 (i.e., the terminal voltage). The terminal voltage of traction battery 24 is measurable.

Parameters of ECM 80 include the resistors (i.e., resistor R₀, resistor R₁, and resistor Rₙ) and the capacitors (i.e., capacitor C₁ and capacitor Cₙ). The parameters are to have values whereby the calculated output of ECM 80 in response to a hypothetical given input is representative of the actual output of traction battery 24 (e.g., battery terminal voltage) in response to the actual given input (e.g., battery discharge/charge current). As such, the values of the parameters of ECM 80 have to be accurate so that the ECM accurately models the behavior of traction battery 24.

As indicated, the values of the parameters of the ECM can be learned online by BECM 50 such as with a Kalman filter. Understandably, it is much easier for BECM 50 to learn the values of a few parameters as opposed to learning the values of many parameters. Consequently, as a practical matter, ECM 80 is typically only a 1-RC ECM or a 2-RC ECM.

BECM 50 is operable to measure operating characteristics of traction battery 24 using the ECM with the learned values of the parameters. In turn, controller 48 controls the operation of traction battery 24 and/or BEV 12 based on the measured operating characteristics of the traction battery.

As described, traction battery 24 provides power to propel BEV 12. The amount of power provided by traction battery 24 is a function of the battery current and the battery terminal voltage of the traction battery. As the battery current is being provided from traction battery 24, the battery current is an output battery current. BECM 50 uses measurements of the battery current (i.e., an input) and the battery terminal voltage (i.e., an output), as well as the battery temperature, to drive a Kalman filter to estimate values of parameters and states of the ECM. The amount of power provided by traction battery 24 to propel BEV 12 changes as the BEV is being driven. For instance, traction battery 24 provides more power while BEV 12 is going faster and provides less power while the BEV is going slower. As the power provided by traction battery 24 changes, the battery current and the battery terminal voltage change. Consequently, BECM 50 measures different battery current and battery terminal voltage combinations while BEV 12 is being driven enabling the Kalman filter to be driven with a diverse set of measurements so that the values of parameters and states of the ECM are accurately estimated. In this regard, persistent excitation to a system is needed in order to have accurate parameter estimation. The idea is that the input to the system should excite the different modes of the system such that each parameter's effect on the system output can be detected, and thus, its value determined. (The described scenario of traction battery 24 providing power to propel BEV 12 involves the traction battery being discharged to provide the output battery current. Of course, the scenario in which traction battery 24 is being charged by traction motor 14 functioning as a generator may also be used in driving the Kalman filter in estimating the values of parameters and states of the ECM.)

As further described, traction battery 24 may be charged using a charge current from an external power source (e.g., power source 36), such as when BEV 12 is parked at a charge station having the external power source. The charge current is outputted from the charge station (i.e., power source 36) to BEV 12. In the case of the charge current outputted by the charge station being an AC charge current, power conversion module 32 of BEV 12 converts the AC charge current into a DC charge current and inputs the DC charge current to traction battery 24 to charge the traction battery. Notably, the converted DC charge current differs with different AC charge currents. In the case of the charge current outputted by the charge station being a DC charge current, the DC charge current is inputted directly to traction battery 24 to charge the traction battery. As such, in either case of the charge current from the charge station being an AC charge current or a DC charge current, the charge current from the charge station is used to charge traction battery 24. The charge current inputted to traction battery 24 is an input battery current. Typically, the charge current outputted by the charge station has consistent attributes (e.g., DC charge current at a constant voltage; AC charge current at a constant frequency with a constant amplitude, etc.). Accordingly, BECM 50 would measure uniform battery current and battery terminal voltage combinations while traction battery 24 is being charged using such consistent charge current from the charge station. Consequently, there would not be a diverse set of measurements depictive of actual vehicle driving conditions for driving the Kalman filter.

In accordance with the present disclosure, BECM 50 is configured to function with power source 36 for the power source to actively vary the charge current while the charge current is being used to charge traction battery 24. For instance, within the capability and limits of power source 36, BECM 50 is operable to command the power source to vary the charge current. By BECM 50 actively varying the charge current, i.e., by the BECM performing “active charge control”, the BECM causes the charge current to change from a “regular” charge current having consistent attributes to an “active” charge current having attributes more depictive of the charge current experienced during actual vehicle driving conditions. Consequently, with the active charge control, the Kalman filter may be driven with a diverse set of measurements depictive of measurements during actual vehicle driving conditions so that the values of parameters and states of the ECM may be accurately estimated while traction battery 24 is being charged at the charge station. In turn, BECM 50 can measure operating characteristics of traction battery 24 using the ECM with the learned values of the parameters while traction battery 24 is being charged at the charge station.

As set forth, BECM 50 is operable to employ an active charge control scheme to modulate charge current from a charge station when traction battery 24 is being charged at the charge station. In general, through hand shaking between BECM 50 and the charge station, a pre-determined, active charge profile consistent with battery charge power capability is executed. Per the active charging control, during charging, BECM 50 modulates the charge current requested based on the charge power capability constraints, and the desire to have a modulated, charge current so the persistent execution conditions can be met. By actively changing charging current to excite traction battery 24, ECM parameters and states can be learned during the charging phase, in the form of a Kalman filter. That is, instead of using a constant-current or constant-voltage strategy, the active charge control strategy enables learning of ECM parameters and states. One of the states is the SOC of traction battery 24. In this way, BECM 50 obtaining an accurate SOC during charging is possible, thus generally improving user satisfaction and reducing battery ageing.

As performing active charge control enables BECM 50 to obtain an accurate SOC during charging, the active charge control process enables an accurate estimation of the SOC to be obtained without waiting for traction battery to be “rested”. Given that users normally plug-in their vehicles when reaching home or DCFC charge stations, it is conceivable that soon after the vehicles have reached their destinations, traction battery 24 will not be in the rested state. As a result, related SOC reset, or more broadly capacity learnings of traction battery 24, may not happen. Performing active charge control to modulate the charging current for up to a few minutes provides the opportunity for BECM 50 to learn the ECM parameters and states (SOC) during the charging. Consequently, instead of abandoning capacity estimation due to the user plugging in the vehicle after use, BECM 50 is configured to employ an active charge control strategy to learn the SOC while traction battery 24 is being charged. With the active charge control, the charging current does not have consistent attributes. Instead, the charging power (charging current) can be anything as long as its value is within the power at which power source 36 can provide at that moment and its value is within the (charge) power capability that traction battery 24 can accept.

By varying the charge current for a few minutes per the active charge control, the remaining charging time may not be increased significantly. However, the charging time will be increased to some extent. As such, an issue with active charge control is that it increases charging time. In this regard, by modulating charging current for a given amount of time, the RMS (root-mean-square) current from power source 36 to traction battery 24 is less than the allowed charging current from the power source for the same duration of time. Accordingly, for DC fast charge in which charging time is at a premium, it may not be feasible to perform the active charge control for more than a relatively small percentage of the charging time. Conversely, for AC charging (e.g., L2 charging) in which charging time is not as sensitive, it is more feasible to perform the active charge control for a greater percentage of the charging time.

In accordance with the present disclosure, as charging time is a performance measure for electric vehicles, BEC 50 is configured to address how to utilize the active charge control process in order to maintain total charging time within acceptable levels. BECM 50, having the capability of identifying what kind of charge station is connected to traction battery 24 and what kind of charging is going to occur, is configured to arrange the active charge control accordingly.

In general, BECM 50 is configured to perform active charge control during charging of traction battery 24 at a charge station. BECM 50 modifies the active charge control depending on charger type of the charge current provided by the charge station. If the charger type is AC charging (i.e., if the charging current provided by the charge station is AC charging current), then BECM 50 performs active charge control for a relatively greater percentage of the charging time. With AC charging the charging time is less sensitive. Therefore, BECM 50 uses the active charging control in intervals of SOCs of traction battery. For example, at every 5% SOC increase, the active charge control can be used for a period following which regular charging is used. If the charger type is DC charging (e.g., DCFC) (i.e., if the charge current provided by the charge station is DC charging current), then BECM 50 performs active charge control for a relatively smaller percentage of the charging time. With DC charging the charging time is more sensitive, especially when the user pays for the usage of time spent by the charger. Therefore, the active charge control can be used just once for a period at the beginning of the charging following which regular charging is used.

In operation, once the charger plug of the charge station is connected with BEV 12, BECM 50 uses its hardware and protocol to identify the charging type. As indicated, the typical charging types include AC charging (e.g., L2 charging) and DC charging (e.g., DC fast charging). As further indicated, constraints pertaining to the active charging include the charging current being limited by charger (charger limit) and BECM 50 (battery limit). There may be other reasons to limit the charge current. As BECM 50 commands power source 36 to vary the charge current when performing the active charge control, other constraints include the maximum message rate at which the BECM and the power source can communicate with one another. Once the charger is determined, given the associated message rate between the charger and BECM 50, the BECM achieves better use of the charger information by branching out the active charge control strategy according to the charger information.

As an aside, an example will be used to show how much active charge control increases total charging time. In this example, without loss of generality, assume the total charge time is two hours and that 40 A is the maximum charging current. Based on a real-world study, one active charge control event can last one minute. Assuming the RMS current optimally will be 40 A, add 20 A as a base and 20*sin(4*π*t) as a dynamic trace: the RMS for 20+20*sin(4*π*t) for two minutes is 24.49 A. The wasted charging time can be calculated based on RMS current. Before is one minute; after is (40/24.49)*1=1.63 minutes; meaning that the added charging time is 37 seconds for each active charging control action, for this example. In other words, the ratio of the original charging current vs. the active charge current determines the extra time needed to charge up to the same SOC level in one minute. Note that when SOC is high, normally charging current becomes smaller.

In summary, in accordance with the present disclosure, BECM 50 is configured to perform active charge control during charging of traction battery 24 at a charge station. BECM 50 sets the amount of active charge control performed as a function of charger type. The amount of active charge control performed is more when the charger type pertains to AC charging (i.e., when the current flowing from the charge station into BEV 12 is AC current) than when the charger type pertains to DC charging (i.e., when the current flowing from the charge station into BEV 12 is DC current). In either case, while traction battery 24 is being charged at the charge station, the active charge control performed enables BECM 50 to learn ECM parameters and states with more accuracy than if no active charge control had been performed.

As such, BECM 50 provides for implementing the active charge control selectively to thereby reduce its effect on the charging time while still achieving the overall learning goal. In operation, at the commencement of plug-in charging at a charge station, BECM 50 detects which type of charging will occur, e.g., AC or DC (fast) charging. During AC charging, BECM 50 implements the active charge control in intervals of SOC, with the ECM parameters and states being estimated at each SOC interval and with an ampere-hour (Ah) integration measurement being used to detect the SOC intervals. During DC charging, BECM 50 implements the active charge control only at the beginning of the charging and with the Ah integration measurement being used to detect the final SOC at the end of the charging.

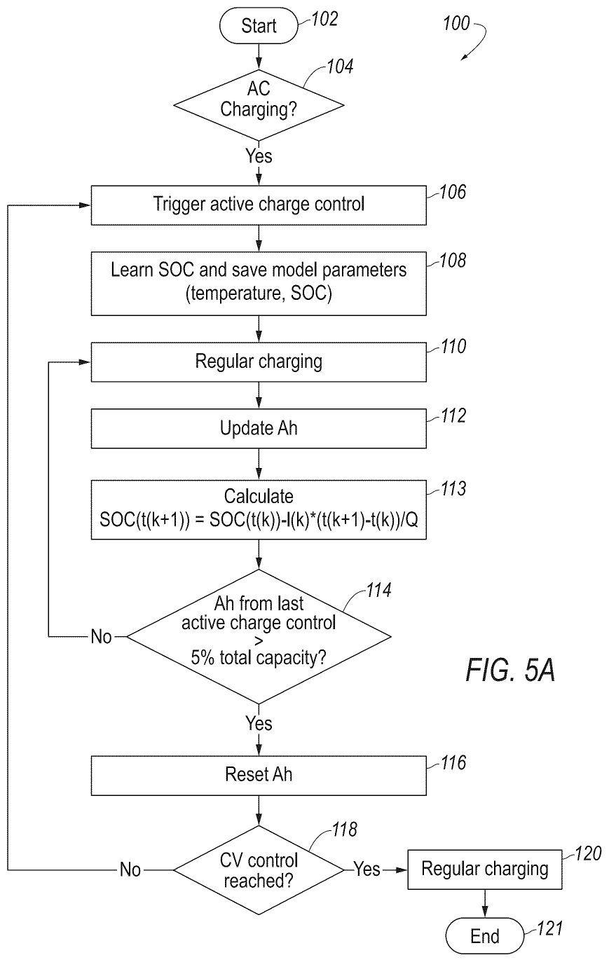

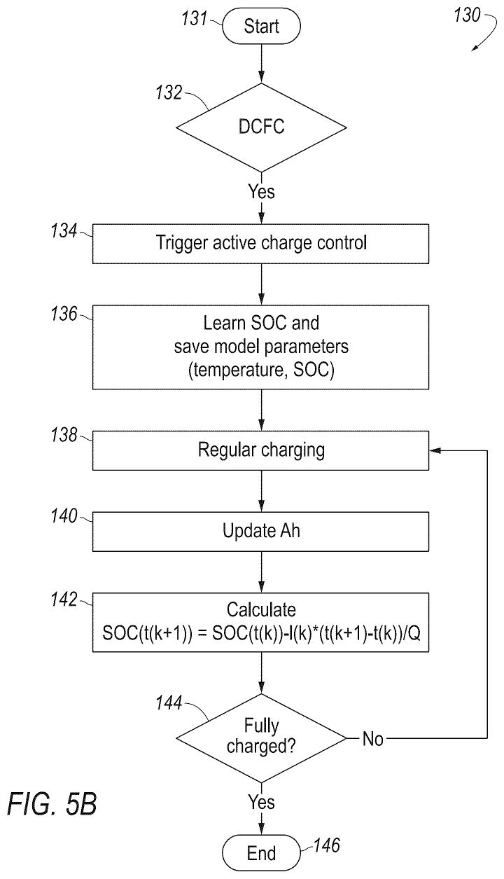

Referring now to FIG. 5A, a flowchart 100 depicting operation of BECM 50 when traction battery 24 is being charged at a charge station that provides AC charging current is shown. In general, the operation includes BECM 50 using active charge control of the AC charging current in a manner that is customized to AC charging for the BECM to detect operating characteristics of traction battery 24 while the traction battery is being charged by an AC charger of BEV 12 that converts the AC charging current into DC charging current and charges the traction battery with the DC charging current. As such, flowchart 100 pertains to active charge control for AC charging.

As overview, the active charge control for AC charging involves periodically triggering the active charging control every 5% (calibratable) SOC change. As an aside, recall from the above example that the added charging time is 37 seconds for every active charging control action. The control operation includes BECM 50 triggering the active charge control at the start of charging. During the active charge control, BECM 50 learns the SOC and parameters of the ECM at the current temperature and at the current SOC of traction battery 24. BECM 50 then performs an Ah integration measurement. Once the Ah integration measurement reaches 5% (calibratable) of total capacity, i.e., once the Ah integration measurement is indicative of the next SOC interval being achieved, BECM 50 triggers the active charge control once more and learns the SOC and parameters of the ECM at the current temperature and at the current SOC of traction battery 24. The process of triggering the active charge control to learn the SOC and parameters of the ECM at a SOC interval followed by performing the Ah integration measurement until the next SOC interval is reached is repeated until the constant voltage (or constant current) charging mode is reached. As charging current is winding down, it may best to limit use of active charge control. However, repeated use of the active charge control may still be used if the charger power and battery charge power capability are respected.

Assuming N events of active charge control occur, the total charge time, per the above example, will be 37*N seconds longer. One extreme is from 0% SOC all the way to 100% SOC. In this case, N=21 and the charging time increase will be 777 seconds (21 events*37 seconds/event=777 seconds). For the AC charging case, a relatively better active charging profile can be designed, and extra charge time can be reduced while the overall learning goal is achieved.

In further detail, with reference to flowchart 100 of FIG. 5A, the operation of the active charge control for AC charging starts with traction battery 24 and power source 36 being connected for the power source to charge the traction battery, as indicated by process block 102. BECM 50 communicates with power source 36 to detect that traction battery 24 will be charged using AC charge current from the power source, as indicated in decision block 104. As a result, BECM 50 implements the active charge control for AC charging. The active charge control for AC charging includes BECM 50 triggering an active charge control event at the start of charging, as indicated by process block 106. BECM 50 learns the SOC and parameters of the ECM at the current temperature and at the current SOC of traction battery 24 during the active charge control event, as indicated by process block 108. At the end of the active charge control event, BECM 50 terminates the active charge control such that power source 36 provides the ordinary, consistent charge current to traction battery 24, i.e., such that the power source implements regular charging of the traction battery, as indicated by process block 110. During the regular charging, BECM 50 performs an Ah integration measurement and updates a value of the SOC based on the Ah integration measurement, as indicated by process blocks 112 and 113. (Regarding the equation shown in process block 113 for the SOC update, in the past time period (t(k+1)−t(k)), there is a constant current I(k) used, and the SOC is updated based on the changed Ah value divided by capacity, and modified from the last SOC. This equation assumes that discharge current is positive.)

BECM 50 continues with the regular charging and performs the Ah integration measurement until the Ah integration from the last active charge control event is greater than a predetermined threshold, for example 5% of total capacity, as indicated by decision block 114. The predetermined threshold is indicative of the next SOC interval, which in this example is the next 5% SOC change.

Upon the Ah integration being greater than the predetermined threshold, BECM 50 resets the Ah integration measurement, as indicated by process block 116. BECM 50 then determines whether power source 36 is to implement constant voltage (or constant current) charging of traction battery 24, as indicated by decision block 118. Constant voltage (or constant current) charging is the regular charging. BECM 50 makes this determination based on whether the updated SOC value is sufficiently near a desired SOC value (e.g., 100%). If BECM 50 determines that power source 36 is to implement the constant voltage charging, then the BECM causes the power source to perform the regular charging, as indicated by process block 120.

If BECM 50 determines that power source 36 is not yet to implement the constant voltage charging, then the BECM repeats another round of the operation steps of blocks 106, 108, 110, 112, 113, 114, 116, and 118. Particularly, BECM 50 triggers another active charge control event per process block 106, learns the SOC and parameters of the ECM at the current temperature and at the current SOC of traction battery 24 during this active charge control event per process block 108, terminates this active charge control and implements regular charging per process block 110, performs another Ah integration measurement per process block 112 until this Ah integration is greater than the predetermined threshold per decision block 114, resets the Ah integration measurement per process block 116, determines whether power source 36 is to now implement constant voltage (or constant current) charging of traction battery 24 per decision block 118, and causes the power source to perform the regular charging per process block 120 or continue with another round of these operation steps. The regular charging per process block 120 is continued until traction battery 24 is fully charged at which time the charging by power source 36 is terminated as indicated by process block 121.

Referring now to FIG. 5B, a flowchart 130 depicting operation of BECM 50 when traction battery 24 is being charged at a charge station that provides DC charging current is shown. In general, the operation includes BECM 50 using active charge control of the DC charging current in a manner that is customized to DC charging for the BECM to detect operating characteristics of traction battery 24 while the traction battery is being charged with the DC charging current. As such, flowchart 100 pertains to active charge control for DC charging, i.e., DC fast charging.

As overview, the active charge control for DC fast charging involves triggering the active charging control only once (or only relatively few times). The control operation includes BECM 50 triggering the active charge control at the start of charging. During the active charge control, BECM 50 learns the SOC and parameters of the ECM at the current temperature and at the current SOC of traction battery 24. The learned SOC can serve as the SOC value at the starting time, i.e., SOC(0), where time (t)=0. The BECM then discontinues the active charge control in favor of regular charging and performs an Ah integration measurement during the regular charging. BECM 50 uses the subsequent Ah value and the capacity value to calculate the charge-end SOC: SOC(t)=SOC(t0)−Ah/Q, where t0 is the moment SOC is learned and the active charge control is ended (the naming convention is that the charging current is negative during charging).

For DC fast charging, assuming only one active charge control occurs, the total charging time increase is 37 seconds, per the example above. For the DC fast charging case, a relatively better active charging profile can be designed, and extra chare time can be reduced while the overall learning goal is achieved.

In further detail, with reference to flowchart 130 of FIG. 5B, the operation of the active charge control for DC fast charging starts with traction battery 24 and power source 36 being connected for the power source to charge the traction battery, as indicated by process block 131. BECM 50 communicates with power source 36 to detect that traction battery 24 will be charged by the power source with DC fast charge current, as indicated in decision block 132. As a result, BECM 50 implements the active charge control for DC fast charging. The active charge control for DC fast charging includes BECM 50 triggering an active charge control event at the start of charging, as indicated by process block 134. BECM 50 learns the SOC and parameters of the ECM at the current temperature and at the current SOC of traction battery 24 during the active charge control event, as indicated by process block 136. At the end of the active charge control event, BECM 50 terminates the active charge control such that power source 36 implements regular charging of the traction battery, as indicated by process block 138. During the regular charging, BECM 50 performs an Ah integration measurement and updates a value of the SOC based on the Ah integration measurement, as indicated by process block 140 and 142, respectively. BECM 50 continues with the regular charging and performs the Ah integration measurement until the updated SOC value is sufficiently near a desired SOC value (e.g., 100%), i.e., until traction battery 24 is fully charged, as indicated by process block 144. Once traction battery 24 is fully charged, the charging by power source 36 is terminated as indicated by process block 146.

In certain cases, a charge station which provides DC fast charging may also provide AC charging. As discussed above, the AC related active charge control can be triggered multiple times without causing meaningful delay in total charging time. Hence, when there is a specific desire to do so, an advice can be provided to the vehicle to use AC charging. When the capacity learning process requires an accurate SOC for the sake of calculating capacity it is helpful to learn SOC during the charge process. A good option is to use AC charging as it leads to more accurate parameter and SOC estimation as duration of active charge control can last longer. Further, if an ECM parameter map has not been updated, then it may be advised for the vehicle user to use AC charging, so ECM parameters can be learned by a given interval of total Ah charged.

As described, a traction battery controller (i.e., BECM) in accordance with the present disclosure is configured to use active charge control of charge power from a charge station to detect operating characteristics of a traction battery while the traction battery is being charged with the charge power in which the amount of active charge control is customized to the type of charge power. More active charge control is performed for one type of charge power than for another type of charge power. For instance, more active charge control is performed when the charge power is an AC charge power than when the charge power is a DC charge power.

As described, proposed strategies in accordance with the present disclosure have the following attributes. First, charger type is recognized to trigger different active charge control strategies. Second, for AC charging, as charging time duration is more lenient, multiple instants of active charge control can be triggered. This way, battery model parameters and SOC values can be learned. Third, for DC fast charging, as charging time performance is more stringent, only one active charging control event may be triggered. It is still possible to learn battery model parameters and SOC value at the instant the DC fast charging is plugged-in, and charging has started. Fourth, an advisory system can be designed to ask the vehicle user to use AC charging whenever there is a need to have multiple active charge control events to benefit both battery capacity and battery model parameter updates. For example, if capacity has not been learned and an accurate SOC (without using Ah counting) is needed, then the BECM may decide to trigger an active charging control event. During discharge, although HVAC or heater may be run to drive the excitation of the battery, the effect on various components such as warrant affect is far more complicated compared with charge time increase (by a little bit).

In summary, the present disclosure provides a system and a method of applying active charge control for battery model parameters and SOC estimation wherein a charger type is identified by the battery controller; when the charger type is AC charging, a sequence of active charging control is arranged, and battery model parameters and states (SOC) can be learned at an interval of Ah value, such as 5% of total capacity; and when the charger type is DC fast charging, due to time constraint, only one active charge control is triggered. A special active charge control event may be arranged based on battery controller needs, such as learning specific battery model parameters at a given temperature and SOC value. An advisory system can be used to advise vehicle users to use AC charging, in case there is a need to learn battery model parameters and SOC, for the purpose of capacity learning or model parameter set update.

While exemplary embodiments are described above, it is not intended that these embodiments describe all possible forms of the present disclosure. Rather, the words used in the specification are words of description rather than limitation, and it is understood that various changes may be made without departing from the spirit and scope of the present disclosure. Additionally, the features of various implementing embodiments may be combined to form further embodiments of the present disclosure.

What is claimed is:

1. A method comprising:
varying a current, from a charge station for use in charging a battery, depending on a type of the current;
measuring a voltage of the battery as the current is being varied;
driving an estimator with the voltage to output a state-of-charge (SOC) of the battery; and
operating the battery according to the SOC.

2. The method of claim 1 further comprising:
varying the current for a duration of time depending on the type of the current.

3. The method of claim 2 further comprising:
varying the current for a greater duration of time when the current is AC charging current than when the current is DC charging current.

4. The method of claim 1 further comprising:
varying the current for one or more instants depending on the type of the current; and
unchanging the current other than during the one or more instants.

5. The method of claim 4 further comprising:
varying the current for multiple instants when the current is AC charging current.

6. The method of claim 5 further comprising:
performing Ampere integration measurements while the current is being unchanged, wherein the instants are delineated according to SOC intervals based on the SOC and the Ampere integration measurements performed between neighboring instants.

7. The method of claim 4 further comprising:
varying the current for just one instant when the current is DC charging current.

8. The method of claim 7 wherein:
the one instant occurs when the current is initiated from the charge station to the battery.

9. The method of claim 8 further comprising:
performing an Ampere integration measurement while the current is being unchanged; and
upon the current from the charge station to the battery being terminated, detecting a final SOC based on the SOC and the Ampere integration measurement.

10. A system comprising:
a controller configured to vary a charge current, from a charge station for use in charging a battery, depending on a type of the charge current;
a sensor configured to measure a terminal voltage of the battery as the charge current is being varied;
the controller further configured to drive an estimator with the terminal voltage to output a state-of-charge (SOC) of the battery and to charge/discharge the battery based on the SOC.

11. The system of claim 10 wherein:
the controller is further configured to vary the charge current for a greater duration of time when the charge current is AC charge current than when the charge current is DC charge current.

12. The system of claim 10 wherein:
the controller is further configured to vary the charge current for one or multiple instants depending on the type of the charge current and to un-change the charge current other than during the one or multiple instants.

13. The system of claim 12 wherein:
the controller is further configured to vary the charge current for multiple instants when the charge current is AC current and to perform Ampere integration measurements while the charge current is being unchanged, wherein the instants are delineated according to SOC intervals based on the SOC and the Ampere integration measurements performed between neighboring instants.

14. The system of claim 12 wherein:
the controller is further configured to vary the charge current for just one instant when the charge current is DC charge current; and
the controller is further configured to perform an Ampere integration measurement while the charge current is being unchanged, and, upon the charge current from the charge station to the battery being terminated, detect a final SOC based on the SOC and the Ampere integration measurement.

15. The system of claim 14 wherein:
the one instant occurs when the charge current is initiated from the charge station to the battery.

16. An electrified vehicle comprising:
a traction battery; and
a controller configured to vary a charge current, from a charge station for use in charging the traction battery, depending on a type of the charge current, measure a terminal voltage of the traction battery as the charge current is being varied, drive an estimator, that utilizes voltage feedback based on a model of the battery to provide parameter/state estimations of the battery, with the terminal voltage to output a state-of-charge (SOC) of the battery, and to charge/discharge the traction battery based on the SOC.

17. The electrified vehicle of claim 16 wherein:
the controller is further configured to vary the charge current for a greater duration of time when the charge current is AC charge current than when the charge current is DC charge current.

18. The electrified vehicle of claim 16 wherein:
the controller is further configured to vary the charge current for one or multiple instants depending on the type of the charge current and to un-change the charge current other than during the one or multiple instants.

19. The electrified vehicle of claim 18 wherein:
the controller is further configured to vary the charge current for multiple instants when the charge current is AC charge current and to perform Ampere integration measurements while the charge current is being unchanged, wherein the instants are delineated according to SOC intervals based on the SOC and the Ampere integration measurements performed between neighboring instants.

20. The electrified vehicle of claim 18 wherein:
the controller is further configured to vary the charge current for just one instant when the charge current is DC charge current, the one instant occurs when the charge current is initiated from the charge station to the traction battery; and
the controller is further configured to perform an Ampere integration measurement while the charge current is being unchanged, and, upon the charge current from the charge station to the traction battery being terminated, detect a final SOC based on the SOC and the Ampere integration measurement.
